(19) United States
(12) Patent Application Publication
(10) Pub. No.: US 2012/0300465 A1
(43) Pub. Date: Nov. 29, 2012

(54) DISPLAY DEVICE

(75) Inventors: Sun-Young CHANG, Gwangmyeong-si (KR); Se-Ah KWON, Seoul (KR); Chang-Soon JANG, Seoul (KR)

(73) Assignee: SAMSUNG ELECTRONICS CO., LTD., Suwon-si (KR)

(21) Appl. No.: 13/295,432

(22) Filed: Nov. 14, 2011

(30) Foreign Application Priority Data
May 26, 2011 (KR) 10-2011-0049935

(51) Int. Cl. F21V 9/08

(52) U.S. Cl. 362/293

(57) ABSTRACT

A display device includes a light-emitting module and a color filter. The color filter transmits light provided from the light-emitting module and represents a color green which has a y-coordinate between about 0.565 and about 0.578 in CIE 1931 chromaticity diagram.

### CROSS REFERENCE TO RELATED APPLICATION

This application claims priority from and the benefit of Korean Patent Application No. 10-2011-49935, filed on May 26, 2011, which is hereby incorporated by reference for all purposes as if fully set forth herein.

### BACKGROUND OF THE INVENTION

1. Field of the Invention

Exemplary embodiments of the present invention relate to a display device, more particularly, to a display device using a light-emitting diode (“LED”).

2. Discussion of the Background

Generally, a display device includes a display panel displaying an image using light and a backlight assembly providing the light to the display panel. The display panel includes a plurality of pixel cells, and each of the pixel cells includes a switching element, a pixel electrode, a common electrode, and a color filter. The display panel may use a liquid crystal molecule as a display element.

The backlight assembly includes a light-emitting module and optical members for efficiently providing the light received from the light-emitting module to the display panel. Examples of the light-emitting modules include a cold cathode fluorescent lamp (“CCFL”), an external electrode fluorescent lamp (“EFFL”), etc. Recently, in order to improve luminance and decrease the size of the backlight assembly, an LED is generally used as the light-emitting module.

White light emitted from the light-emitting module is transmitted to a liquid crystal layer including a liquid crystal molecule and a color filter so that the display panel may display a color image through a variable color mixture. For example, the display panel may include a red color filter (R), a green color filter (G), and a blue color filter (B), and three color lights passing through the display panel are mixed to represent various colors.

Color reproducibility due to the color filters may be influenced by a type or a combination of coloring agents representing a color included in the color filter, or a spectrum changed according to a type of a light source. Thus, although substantially the same light source may be used, the color reproducibility may be changed by the type or the combination of the coloring agents included in the color filter. In addition, although the color reproducibility may be optimized, if a type of the light source is changed, the spectrum results in changes that may decrease the color reproducibility.

Components of the color filter may be deformed by a curing process of forming the color filter or a plurality of curing processes performed after forming the color filter. In addition, the components of the color filter may be deformed by the heat generated from the backlight assembly. Therefore, although a color filter includes components optimized in theory, a color shift representing different color from an original color of the color filter may be generated in forming the color filter or using the color filter.

The above information disclosed in this Background section is only for enhancement of understanding of the background of the invention and therefore it may contain information that does not form any part of the prior art.

### SUMMARY OF THE INVENTION

Exemplary embodiments of the present invention provide a display device including a color filter capable of maintaining color reproducibility and reducing a color shift although an LED is used as a light source.

Additional features of the invention will be set forth in the description which follows, and in part will be apparent from the description, or may be learned by practice of the invention.

An exemplary embodiment of the present invention discloses a display device includes a light-emitting module to transmit light; and a color filter to receive light from the light-emitting module and to represent a color green which has a y-coordinate between about 0.565 and about 0.571 in a CIE 1931 chromaticity diagram.

An exemplary embodiment of the present invention also discloses a display device including: a light-emitting module to transmit light; and a color filter to receive light from the light-emitting module, wherein the color filter comprises a green coloring agent and a yellow coloring agent, the yellow coloring agent comprising a dye and a pigment at a weight ratio is between about 1:13 and about 9:13.

An exemplary embodiment of the present invention also discloses a color filter for a display device, comprising: a green coloring agent; and a yellow color agent comprising a dye and a pigment at a weight ratio between about 1:13 and about 9:13.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view of a display device according to an exemplary embodiment of the present invention.

FIG. 2 is a CIE 1931 chromaticity diagram of a color filter according to an exemplary embodiment of the present invention.

FIG. 3 is a cross-sectional view of a light-emitting module of FIG. 1 according to an exemplary embodiment of the present invention.

FIG. 4 is a graph of a light-transmittance according to an exemplary embodiment of the present invention.

FIG. 5 is a cross-sectional view of a display device according to an exemplary embodiment of the present invention.

FIG. 6 is a graph of a light-transmittance according to a wavelength according to an exemplary embodiment of the present invention.

FIG. 7 is an enlarged portion of the graph of FIG. 6 according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

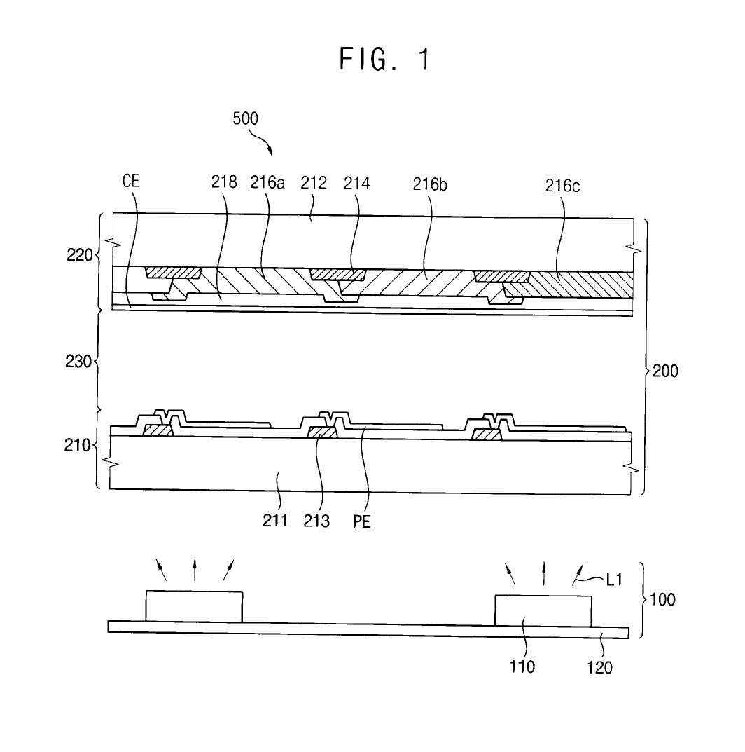

FIG. 1 is a cross-sectional view of a display device according to an exemplary embodiment of the present invention.

Referring to FIG. 1, a display device 500 includes a backlight assembly 100 and a is display panel 200.

The backlight assembly 100 includes a light-emitting module 110 emitting white light L1. The light-emitting module 110 may be mounted on a printed circuit board 120 providing a light driving signal to the light-emitting module 110. The light-emitting module 110 provides white light L1 to the display panel 200. The light-emitting module 110 will be illustrated with reference to FIG. 3. Although not shown in the figures, the backlight assembly 100 may further include optical sheets and/or optical plates disposed between the light-emitting module 110 and the display panel 200.

The display panel 200 includes a first display substrate 210, a second display substrate 220, and a liquid crystal layer 230. The display panel 200 may display an image using the white light L1 provided from the backlight assembly 100. The second display substrate 220 faces the first display substrate 210, and the liquid crystal layer 230 is interposed between the first and second display substrates 210 and 220.

The first display substrate 210 includes a thin-film transistor (“TFT”) 213 as a switching element formed on a first base substrate 211, a pixel electrode PE electrically connected to the TFT 213, and signal lines (not shown). The TFT 213 may control turning on/off of each pixel cell of the display panel 200. The TFT 213 includes a control electrode (not shown), an input electrode (not shown) and an output electrode (not shown), and the output electrode may directly make contact with the pixel electrode PE. The TFT 213 is electrically connected to the signal lines.

The second display substrate 220 includes a light-blocking pattern 214 formed on a second base substrate 212 facing the first base substrate 211, color filter 216a, color filter 216b and color filter 216c, an over-coating layer 218 and a common electrode CE.

The light-blocking pattern 214 is formed on the second base substrate 212 on a region corresponding to a region in which the TFT 213 and the signal lines connected to the TFT 213 are formed.

Each of the color filter 216a, color filter 216b, and color filter 216c is formed on the second base substrate 212 on a region corresponding to a region in which the pixel electrode PE is formed. The color filter 216a, color filter 216b, and color filter 216c include a green color filter 216a, a blue color filter 216b, and a red color filter 216c. The green color filter 216a has the highest light-transmittance in a wavelength between about 500 nm and about 560 nm. For example, the green color filter 216a transmits light having a wavelength between about 500 nm and about 560 nm and absorbs light having a wavelength excluding the wavelength between about 500 nm and about 560 nm to represent green. The blue color filter 216b has the highest light-transmittance in a wavelength between about 420 nm and about 460 nm, and the red color filter 216c has the highest light-transmittance in a wavelength between about 590 nm and about 620 nm.

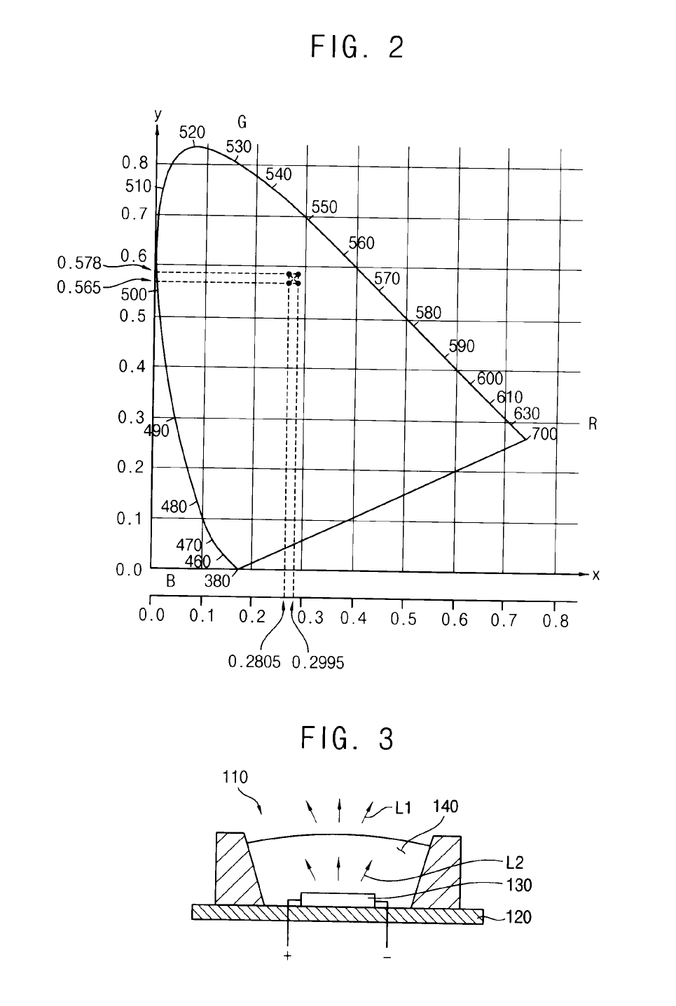

Hereinafter, the green color filter 216a will be illustrated in detail with reference to FIG. 2 and FIG. 3.

FIG. 2 is a CIE 1931 chromaticity diagram of a color filter according to an exemplary embodiment of the present invention.

FIG. 2 is a CIE 1931 chromaticity diagram which refers to a standard colorimetric system established by the Commission Internationale de l'Eclairage (“CIE”) to represent various colors using an x-coordinate and a y-coordinate. A curved line on the CIE 1931 chromaticity diagram represents a monochromatic light and a value referred to on the curved line represents a wavelength (unit: nanometer) of the monochromatic light. The CIE 1931 chromaticity diagram is represents green in a wavelength between about 500 nm and about 560 nm. In a coordinate “(x, y)” for green of CIE 1931 chromaticity, a y-coordinate is a main coordinate and an x-coordinate is as a sub-coordinate. The y-coordinate of green may depend on a thickness of a layer (layer thickness) of the green color filter 216a. For example, as the thickness of a layer of the green color filter 216a is increased, a value corresponding to the y-coordinate of green is also increased.

When the y-coordinate of green represented by the green color filter 216a is greater than or equal to about 0.565, the light-transmittance may be reduced in a wavelength between about 410 nm and about 480 nm. The layer thickness of the green color filter 216a may be increased to achieve the value corresponding to the y-coordinate of the color green to about 0.565. As the layer thickness of the green color filter 216a is increased, a light-absorption of the green color filter 216a may be increased in a wavelength excluding the wavelength having a maximum light-transmittance. The green color filter 216a having the y-coordinate of green greater than or equal to about 0.565 may represent a color green deeper than a green color filter having the y-coordinate of the color green less than about 0.565. The green color filter 216a having a y-coordinate of the color green greater than or equal to about 0.565 may absorb light having wavelengths between about 410 nm and about 480 nm and a light-absorption of the green color filter 216a may be reduced in the wavelength between about 410 nm and about 480 nm.

If the value corresponding to the y-coordinate of the color green is increased, luminance may decrease because there may be an increase in light-absorption in a wavelength between about 500 nm and about 560 nm. In addition, if the value corresponding to the y-coordinate of the color green is increased, a green coordinate forming a triangle with a blue coordinate and a red coordinate may be changed to decrease an area of the triangle or to deform is the triangle. The decrease of the area of the triangle refers to a reduction in color reproducibility. In addition, if the triangle is deformed, a range of color reproducibility may be changed or decreased. Thus, the y-coordinate of green represented by the green color filter 216a is preferably less than about 0.578. Then, the x-coordinate of the color green represented by the green color filter 216a may be between about 0.2805 and about 0.2995.

According to the above descriptions, the color green represented by the green color filter 216a may be determined to have one coordinate in an area of a quadrangle defined by connecting a first coordinate represented by “(0.2805, 0.565),” a second coordinate represent by “(0.2805, 0.578),” a third coordinate represented by “(0.2995, 0.565)” and a fourth coordinate represented by “(0.2995, 0.578)” with each other. When the color green represented by the green color filter 216a has one coordinate in the area of the quadrangle, the light-transmittance of the green color filter 216a may be reduced in the wavelengths between about 410 nm and about 480 nm.

For example, the light-transmittance of the green color filter 216a in the wavelengths between about 410 nm and about 480 nm may be between about 0% and about 5% . Since the y-coordinate of the color green may depend on the layer thickness of the green color filter 216a, when the light-transmittance of the green color filter 216a is greater than about 5% in the wavelengths between about 410 nm and about 480 nm, the layer thickness of the green color filter 216a may be increased such that the y-coordinate is between about 0.565 and about 0.578. Thereby reducing the light-transmittance of the green color filter 216a in the wavelengths between about 410 nm and about 480 nm.

In a curing process of forming the green color filter 216a or a curing process of forming the red color filter 216b and/or blue color filter 216c, the green photoresist composition is may be partially deformed by heat, the y-coordinate of the color green represented by the green color filter 216a is between about 0.565 and about 0.578 so that the light-transmittance of the green color filter 216a may be reduced in the wavelengths between about 410 nm and about 480 nm. Thus, a coordinate change (Ay) of the color green before and after the curing process is reduced so that a color shift by the green color filter 216a may be reduced.

The green color filter 216a may include a green coloring agent and a yellow coloring agent. The yellow coloring agent may include a pigment and/or a dye. For example, the yellow coloring agent included in the green color filter 216a may be the pigment, the dye, or a mixture of the pigment and the dye. The green coloring agent determines a main color represented by the green color filter 216a and the yellow coloring agent may compensate for the main color. For example, the green coloring agent may include C.I pigment green 58 as the pigment. The yellow coloring agent may include a mono-azo based compound as the dye. The yellow coloring agent may include a pyridine-azo based compound as the dye. The mono-azo based compound may include C.I pigment yellow 150. The pyridone-azo based compound may be represented by Chemical Formula 1.

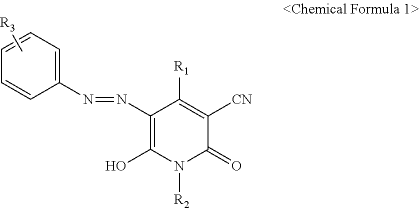

In Chemical Formula 1, R₁, R₂ and R₃ may each independently be one of a hydrogen atom, a hydroxyl group, an alkyl group having from 1 to 30 carbon atoms each, an alkenyl group having from 2 to 30 carbon atoms, an oxyalkyl group having from 1 to 30 carbon atoms, a cycloalkyl group having from 3 to 30 carbon atoms, an aryl group having from 6 to 30 carbon atoms, derivatives, or polymers thereof.

The green color filter 216a may be formed using a green photoresist composition is including a green coloring agent and a yellow coloring agent. The green photoresist composition may further include an initiator for a photo-polymerization, a monomer, a binder, etc., along with the green coloring agent and the yellow coloring agent. The initiator, the monomer, the binder, the green coloring agent and yellow coloring agent may be added into a solvent to form the green photoresist composition. The green photoresist composition is coated on the second base substrate 220 to form a coating layer, and the coating layer is exposed and developed to form the green color filter 216a. The initiator is activated in an exposure process to initiate a cross-linking reaction between the monomer and the binder to harden the green photoresist composition, thereby forming the green color filter 216a. The solvent may be substantially evaporated in forming the green color filter 216a and may be substantially removed from the green color filter 216a.

Similarly, the red color filter 216b and the blue color filter 216c may be formed using a color photoresist composition including at least one coloring agent, an initiator, a monomer and a binder as described above with reference to the green color filter 216a.

FIG. 3 is a cross-sectional view of a light-emitting module of FIG. 1 according to an exemplary embodiment of the present invention.

Referring to FIG. 3, the light-emitting module 110 includes a light-emitting chip 130 to generate light and a light transforming layer 140 to cover the light-emitting chip 140. The light-emitting module 110 may be an LED package including a diode chip as the light-emitting is chip 130. The light-emitting chip 130 generates a blue light L2 and the blue light L2 passes through the light transforming layer 140 to be transformed into the white light L1, thereby providing the white light L1 to an outside of the light-emitting module 110. Thus, although the light-emitting chip 130 generates the blue light L2, a viewer of the light-emitting module 110 may view the white light L1 transformed by the light transforming layer 140.

The blue light L2 generated from the light-emitting chip 130 has a wavelength between about 400 nm and about 500 nm. The light-emitting chip 130 may include gallium nitride (GaN) or indium-gallium nitride (InGaN).

The light transforming layer 140 may include a fluorescent material. The fluorescent material absorbs the blue light L2 generated from the light-emitting chip 130 to transform the blue light L2 into a light having a different wavelength from the blue light L2. The fluorescent material may include a compound to emit red light after absorbing the blue light L2, a compound to emit green light after absorbing the blue light L2, or a compound to emit yellow light after absorbing the blue light L2, etc. Light emitted from the fluorescent material and the blue light L2 are mixed so that the viewer may view the white light L1. For example, the fluorescent material may include selenium-yttrium aluminum oxide (Y₃Al₅O₁₂:Ce), nitrides, silicate, etc.

The blue light L2 has a maximum light-transmittance in a wavelength between about 410 nm and about 480 nm. If the green color filter 216a does not fully absorb light having the wavelength between about 410 nm and about 480 nm, the blue light L2 is mixed with other light resulting in the green color represented by the green color filter 216a being viewed less vividly compared with the blue color of the blue light L2. According to aspects of the present invention, in the CIE 1931 chromaticity diagram shown in FIG. 2, a y-coordinate of the color is green represented by the green color filter 216a may be adjusted to be between about 0.565 and about 0.578, so that the light-absorption of light having wavelengths between about 410 and about 480 nm is increased to reduce the light-transmittance of the light having wavelengths between about 410 and about 480 nm. Therefore, although the light-emitting module 110 includes the light-emitting chip 130 generating the blue light L2, a transmittance property of light passing through the green color filter 216a may be prevented from being decreased by the blue light L2.

Preparation of Sample 1 and Control Sample 1

A green color photoresist composition includes C.I pigment green 58 and a yellow dye, including the Chemical Formula 2 and C.I pigment yellow 150 at a weight ratio of about 12:6, was coated, exposed, and developed to form Sample 1 and Control Sample 1. Sample 1 is a color filter representing the color green and has a coordinate of “(0.2995, 0.5674)” in CIE 1931 chromaticity diagram. The Control Sample 1 is a color filter representing the color green and has a coordinate of “(0.2901, 0.5627)” in CIE 1931 chromaticity diagram. A layer thickness of Sample 1 was about 2.39 μm, and a layer thickness of Control Sample 1 was about 2.21 μm.

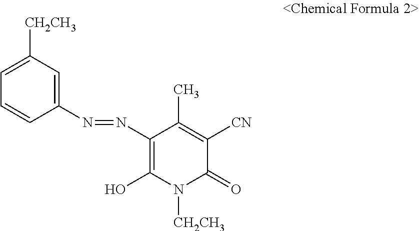

Evaluation of a Light-Transmittance property according to a y-coordinate

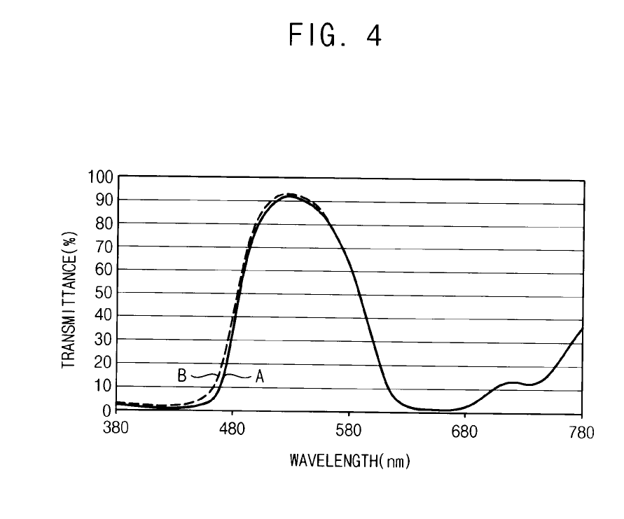

A light-transmittance according to a wavelength in Sample 1 and Control Sample 1 was measured, and the obtained results are illustrated in FIG. 4.

FIG. 4 is a graph of a light-transmittance according to an exemplary embodiment. In FIG. 4, a line A represents a light-transmittance as a function of wavelength for Sample 1 and is a line B represents a light-transmittance as a function of wavelength for Control Sample 1.

Referring to FIG. 4, the light-transmittance represented by the line A in a wavelength between about 410 nm and about 480 nm is lower than the light-transmittance represented by the line B. In addition, a light-absorption of Sample 1 in the wavelength between about 410 nm and about 480 nm is higher than that of Control Sample 1. Thus, although using a light-emitting module including a light-emitting chip generating blue light which has a high light-transmittance in the wavelengths between about 410 nm and about 480 nm, a transmittance property of light passing though Sample 1 may be less than that of light passing though Control Sample 1.

Evaluation of a Color Shift Property According to a Curing Process

Sample 1 and Control Sample 1 were baked to a temperature of about 230° C. A coordinate “(x, y)” of the green color represented by the baked Sample 1 and the baked Control Sample 1 was measured. The results obtained are illustrated in Table 1.

TABLE 1

| | After developing | | After baking | | Color Shift | |
|---|---|---|---|---|---|---|
| | x | y | x | y | Δx | Δy |
| Sample 1 | 0.2995 | 0.5674 | 0.2981 | 0.5639 | 0.0014 | 0.0035 |
| Control | 0.2901 | 0.5627 | 0.2881 | 0.5574 | 0.0021 | 0.0053 |
| Sample 1 | | | | | | |

Referring to Table 1, “Δy” of Sample 1 is smaller than that of the Control Sample 1. Although Sample 1 and Control Sample 1 are both cured to a temperature of about 230° C. after a developing process, a change of the y-coordinate from about 0.5674 to about 0.5639 of Sample 1 is smaller than the change of the y-coordinate of the Control Sample 1. Thus, a color shift of Sample 1 may be less than that of Control Sample 1.

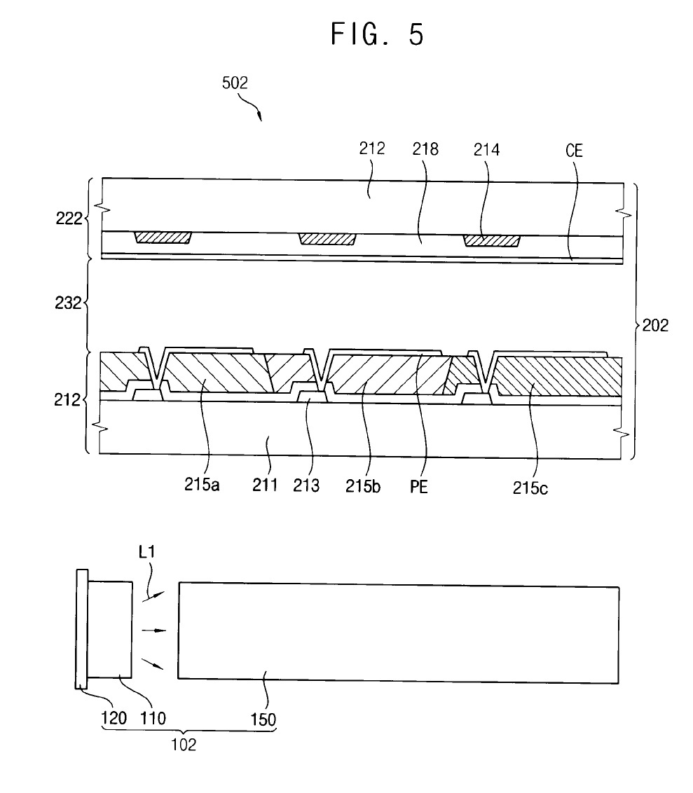

FIG. 5 is a cross-sectional view of a display device according to an exemplary embodiment of the present invention.

Referring to FIG. 5, a display device 502 includes a backlight assembly 102 and a display panel 202.

The backlight assembly 102 is substantially similar to the backlight assembly 100 shown in FIG. 1 except for being an edge-illumination type backlight assembly including a light guide plate 150. Thus, any repetitive descriptions of elements of FIG. 5 are omitted. A light-emitting module 110 of the backlight assembly 102 is disposed in a region corresponding to an edge portion of the display panel 202. A light provided from the light-emitting module 110 may be guided to the display panel 202 by the light guide plate 150 facing the display panel 202. The backlight assembly 102 may be combined with the display panel 200 illustrated in FIG. 1 to form a display device.

The display panel 202 includes a first display substrate 211, a second display substrate 222, and a liquid crystal layer 232. The first display substrate 212 includes a TFT 213 formed on a first base substrate 211, a green color filter 215a, a blue color filter 215b, a red color filter 215c, and a pixel electrode PE.

The green color filter 215a may include a green coloring agent and a mixed is coloring agent. The mixed coloring agent may include a dye and a pigment, and a weight ratio of the dye to the pigment may be between about 1:13 and about 9:13. Thus, the light-transmittance of the green color filter 215a may be between about 0% and about 5% in a wavelength between about 410 nm and about 480 nm. A y-coordinate of a green color represented by the green color filter 215a in CIE 1931 chromaticity diagram may be between about 0.565 and about 0.578. In addition, an x-coordinate of the green color represented by the green color filter 215a may be between about 0.2805 and about 0.2995.

When the green color filter 215a includes the pigment only, luminance is decreased. When the weight ratio between the dye and the pigment is less than about 1:13, the luminance is barely increased by the dye. However, when the weight ratio between the dye and the pigment is greater than about 9:13, the dye may be decomposed by a plurality of curing processes, including the curing process that forms the green color filter 215a the heat resulting in the generation of a color shift of the green color filter 215a resulting in a larger increase in luminance.

For example, the green coloring agent may include C.I pigment green 58. The pigment included in the mixed coloring agent may include a mono-azo based compound. The mono-azo based compound may include C.I pigment yellow 150. The dye included in the mixed coloring agent may include a pyridone-azo based compound. The pyridine-azo based compound may be represented by Chemical Formula 1.

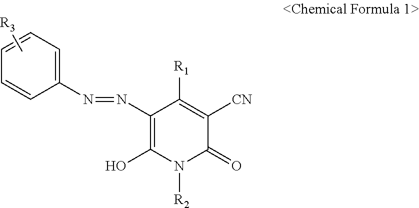

In Chemical Formula 1, R₁, R₂ and R₃ each independently may be one of: a hydrogen atom, a hydroxyl group, an alkyl group having from 1 to 30 carbon atoms, an alkenyl group having from 2 to 30 carbon atoms, an oxyalkyl group having from 1 to 30 carbon atoms, a cycloalkyl group having from 3 to 30 carbon atoms, an aryl group having from 6 to 30 carbon atoms, and derivatives or polymers thereof.

Although not shown in figures, the green color filter 216a shown in FIG. 1 may be replaced with the green color filter 215a illustrated in FIG. 5 to improve a display quality of the display device 500 shown in FIG. 1. Similarly, the green color filter 215a shown in FIG. 4 may be replaced with the green color filter 216a of FIG. 1 to improve a display quality of the display device 502 shown in FIG. 5.

According to the above descriptions, in the green color filter 215a, the mixed coloring agent representing the color yellow added to the green coloring agent includes the dye and the pigment at a weight ratio of between about 1:13 and about 9:13, so that the green color filter 215a may absorbs light having wavelengths between about 410 nm and about 480 nm so that the light-transmittance of light having wavelengths between about 410 nm and about 480 nm may be reduced.

Therefore, although the light-emitting module 110 may include a light-emitting chip generating blue light L2, the transmittance property of light passing through the green color filter 215a may be prevented from being decreased by the blue light L2.

Preparation of Sample 2, 3 and 4 and Control Sample 2

A green color photoresist composition including C.I pigment 58 and a yellow dye, is including the Chemical Formula 2 and C.I pigment yellow 150 at a weight ratio of about 9:13, was coated, exposed, and developed to form Sample 2. Sample 2 is a color filter representing the color green and has a coordinate of “(0.2915, 0.5731)” in CIE 1931 chromaticity diagram.

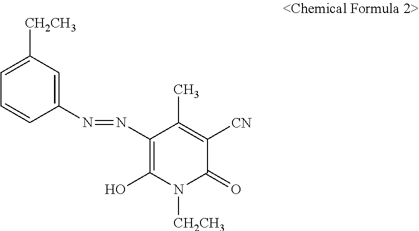

A green color photoresist composition including C.I pigment 58 and a yellow dye, represented by Chemical Formula 2 and C.I pigment yellow 150 at a weight ratio of about 7:13, was coated, exposed, and developed to form Sample 3. Sample 3 is a color filter representing the color green and has a coordinate of “(0.2895, 0.5701)” in CIE 1931 chromaticity diagram.

A green color photoresist composition including C.I pigment 58 and a yellow dye, represented by Chemical Formula 2 and C.I pigment yellow 150 at a weight ratio of about 5:13, was coated, exposed, and developed to form Sample 4. Sample 4 is a color filter representing the color green and has a coordinate of “(0.2847, 0.5650)” in CIE 1931 chromaticity diagram.

In addition, a green color photoresist composition including C.I pigment 58 and a yellow dye, represented by Chemical Formula 2 and C.I pigment yellow 150 at a weight ratio of about 12:13, was coated, exposed, and developed to form Control Sample 2. Control Sample 2 is a color filter representing the color green has a coordinate of “(0.2995, 0.5674)” in CIE 1931 chromaticity diagram.

Evaluation of a Light-transmittance Property according to a y-coordinate

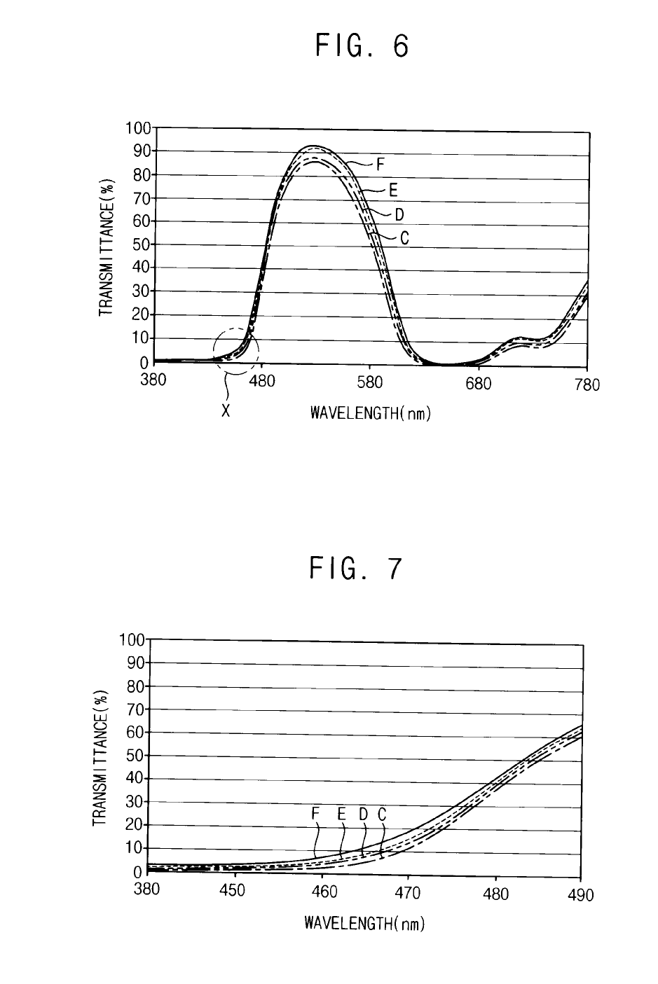

A light-transmittance according to a wavelength for each of Sample 2, Sample 3, Sample 4, and Control Sample 2 was measured, and the results obtained are illustrated in FIG. 6.

FIG. 6 is a graph of a light-transmittance according to a wavelength according to an exemplary embodiment of the present invention. FIG. 7 is an enlarged portion of the graph of FIG. 6 according to an exemplary embodiment of the present invention.

FIG. 6 is a graph of a light-transmittance according to a wavelength for Sample 2, Sample 3, Sample 4, and Control Sample 2, and FIG. 7 is an enlarged graph of a portion “X” in FIG. 6. In FIG. 6 and FIG. 7, line C, line D, and line E represent the light-transmittance according to a wavelength for Sample 2, Sample 3, and Sample 4, respectively, and line F represents the light-transmittance according to a wavelength of Control Sample 2.

Referring to FIG. 7, the light-transmittance shown in the line C, line D, and line E in a wavelength between about 450 nm and about 470 nm is relatively lower than the light-transmittance shown in the line F. Although a light-emitting module including a light-emitting chip generating blue light is used, light-absorptions of Sample 2, Sample 3, and Sample 4 in the wavelength between about 450 nm and about 470 nm is relatively higher than that of Control Sample 2, so that a transmittance property change of light transmitting Sample 2, Sample 3, and Sample 4 may be relatively less than that of light transmitting Control Sample 2.

Evaluation of a Color Shift Property According to a Curing Process

Each of Sample 2, Sample 3, Sample 4, and Control Sample 2 was baked to a temperature of about 230° C. and a coordinate “(x, y)” of the color green represented by baked Sample 2, baked Sample 3, baked Sample 4, and baked Control Sample 2 was measured. The results obtained are illustrated in Table 2.

TABLE 2

| | After developing | | After baking | | Color Shift | |
|---|---|---|---|---|---|---|
| | x | y | x | y | Δx | Δy |
| Sample 2 | 0.2915 | 0.5731 | 0.2909 | 0.5710 | 0.0006 | 0.0021 |
| Sample 3 | 0.2895 | 0.5701 | 0.2905 | 0.5679 | −0.0009 | 0.0022 |
| Sample 4 | 0.2847 | 0.5650 | 0.2849 | 0.5649 | −0.0002 | 0.0001 |
| Control | 0.2995 | 0.5674 | 0.2981 | 0.5639 | 0.0014 | 0.0035 |
| Sample 2 | | | | | | |

Referring to Table 2, “Δy” of each of Sample 2, Sample 3, and Sample 4 is relatively smaller than the “Δy” of Control Sample 2. For example, although Sample 2, Sample 3, Sample 4, and Control Sample 2 are cured in a temperature of about 230° C. after a developing process, a change of the y-coordinate of the Sample 2, Sample 3, and Sample 4 is in a range of about 0.565 to about 0.571, and is relatively smaller than that in the range of Control Sample 2. Thus, a color shift of Sample 2, Sample 3, and Sample 4 may be less than that of Control Sample 2.

According to the exemplary embodiments, a thickness of a layer (or layer thickness) of a color filter is adjusted such that a y-coordinate of a green color represented by the color filter in CIE 1931 chromaticity diagram is between about 0.565 and about 0.578, and thus the color filter may be a green color filter which may fully absorbs light having a wavelength between about 410 nm and about 480 nm. Thus, although a light-emitting module including a light-emitting chip emitting blue light may be combined with a display panel, by including the green color filter to form a display device a color shift of the color green may be reduced in the display device.

In addition, a weight ratio between a dye and a pigment in a mixed coloring agent of the color filter may be adjusted to be between about 1:13 and about 9:13, and thus the color shift of the color green caused by deformations in the components of the color filter in the curing processes performed after forming the color filter may be reduced.

Thus, although a display panel including the color filter representing the color green is combined with a diode package having high luminance and small size as the light-emitting module, a color reproducibility of a display device may be prevented from being decreased to improve a display quality.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device comprising:
a light-emitting module to transmit light; and
a color filter to receive light from the light-emitting module and to represent a color green which has a y-coordinate between about 0.565 and about 0.578 in a CIE 1931 chromaticity diagram.

2. The display device of claim 1, wherein a transmittance of light having a wavelength between about 410 nm and about 480 nm through the color filter is between about 0% and about 5%.

3. The display device of claim 1, wherein the color green has an x-coordinate between about 0.2805 and about 0.2995 in the CIE 1931 chromaticity diagram.

4. The display device of claim 1, wherein the color filter comprises a coloring agent configured to represent the color yellow, the coloring agent comprising at least one of a green coloring agent, a pigment, and a dye.

5. The display device of claim 4, wherein the coloring agent comprises C.I pigment green 58, a mono-azo based compound as the pigment, and a pyridone-azo based compound as the dye.

6. The display device of claim 5, wherein the pyridone-azo based compound is represented by the following chemical formula: 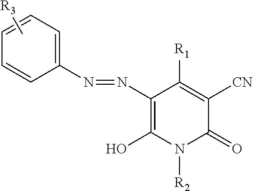
wherein R₁, R₂ and R₃ each independently represents one of a hydrogen atom, a hydroxyl group, an alkyl group having from 1 to 30 carbon atoms, an alkenyl group having from 2 to 30 carbon atoms, an oxyalkyl group having from 1 to 30 carbon atoms, a cycloalkyl group having from 3 to 30 carbon atoms, an aryl group having from 6 to 30 carbon atoms, and derivatives or polymers thereof.

7. The display device of claim 5, wherein the mono-azo based compound comprises C.I pigment yellow 150.

8. The display device of claim 1, wherein the light-emitting module comprises:
a light-emitting chip to emit a blue light; and
a light transforming layer to transform the blue light to a white light, and to emit the white light.

9. A display device comprising:
a light-emitting module to transmit light; and
a color filter to receive light from the light-emitting module,
wherein the color filter comprises a green coloring agent and a yellow coloring agent, the yellow coloring agent comprising a dye and a pigment at a weight ratio between about 1:13 and about 9:13.

10. The display device of claim 9, wherein a transmittance of light having a wavelength between about 410 nm and about 480 nm through the color filter is between about 0% and about 5%.

11. The display device of claim 9, wherein the dye of the yellow coloring agent comprises a pyridone-azo based compound and the pigment of the yellow coloring agent comprises a mono-azo based compound.

12. The display device of claim 11, wherein the pyridone-azo based compound is represented by the following chemical formula 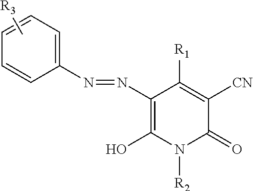
wherein R₁, R₂ and R₃ each independently represents one of a hydrogen atom, a hydroxyl group, an alkyl group having from 1 to 30 carbon atoms, an alkenyl group having from 2 to 30 carbon atoms, an oxyalkyl group having from 1 to 30 carbon atoms, a cycloalkyl group having from 3 to 30 carbon atoms, an aryl group having from 6 to 30 carbon atoms, and derivatives or polymers thereof.

13. The display device of claim 11, wherein the mono-azo based compound comprises C.I pigment yellow 150.

14. The display device of claim 9, wherein the color filter is configured to represent a color green which has a y-coordinate between about 0.565 and about 0.578 in a CIE 1931 chromaticity diagram.

15. The display device of claim 14, wherein the color green has an x-coordinate between about 0.2805 and about 0.2995 in a CIE 1931 chromaticity diagram.

16. The display device of claim 9, wherein the light-emitting module further comprises:
a light-emitting chip to emit a blue light; and
a light transforming layer to transform the blue light to a white light, and to emit the white light.

17. A color filter for a display device, comprising:
a green coloring agent; and
a yellow coloring agent comprising a dye and a pigment at a weight ratio between about 1:13 and about 9:13.

18. A color filter of claim 17, wherein the dye of the yellow coloring agent comprises a pyridone-azo based compound and the pigment of the yellow coloring agent comprises a mono-azo based compound.

19. The color filter of claim 18, wherein the mono-azo based compound comprises C.I pigment yellow 150.

20. The color filter of claim 18, wherein the dye of the yellow color agent includes a compound represented by the following chemical formula: [chemical structure]
